(19) United States
(12) Patent Application Publication
(10) Pub. No.: US 2013/0326574 A1
(43) Pub. Date: Dec. 5, 2013

(54) POWER-SAVING AUDIO/VIDEO CONTROL DEVICE

(71) Applicants: Chih-Chun Ho, New Taipei (TW); Hui-Ming Ho, New Taipei (TW); Chih-Yuan Ho, New Taipei (TW)

(72) Inventors: Chih-Chun Ho, New Taipei (TW); Hui-Ming Ho, New Taipei (TW); Chih-Yuan Ho, New Taipei (TW)

(73) Assignee: ABA ELECTRONICS TECHNOLOGY CO., LTD., New Taipei (TW)

(21) Appl. No.: 13/482,818

(22) Filed: May 29, 2012

(51) Int. Cl. H04N 7/173

(52) U.S. Cl. 725/116

(57) ABSTRACT

A power-saving audio/video control device determines whether to power on/off a public broadcasting system according to a connecting status of a multimedia device through a power-saving control. The multimedia device provides an audio/video signal to be played by the public broadcasting system. The multimedia device includes an input module, a detection unit and a control unit. The audio/video control device plugs and installs the multimedia device directly, and the detection unit detects whether the input module is connected to the multimedia device, so that the control unit controls the power ON/OFF of the public broadcasting system and selects a source port automatically to achieve the effects of providing a plug and play function, turning on or off the power automatically, saving energy, reducing the labor cost, enhancing the service life, automatically switching the audio/video, and providing a convenient operation.

### FIELD OF THE INVENTION

The present invention relates to a power-saving device, in particular to a power-saving audio/video control device that detects whether it is electrically connected to a multimedia device and whether the multimedia device generates an audio/video signal to control a public broadcasting system to perform controls such as power management and synchronously play the audio/video signal at the public broadcasting system.

### BACKGROUND OF THE INVENTION

Audio/video sharing devices are generally installed on wall panels of public open spaces such as classrooms, conference rooms, or audio-visual rooms or tabletops of conference rooms and connected to a shared public broadcasting equipment (such as projectors or LCD TVs) in public open spaces.

A user in the public open space can share audio/video signals generated by the user's personal multimedia device with the public broadcasting equipment through the audio/video sharing device.

In addition, present existing multimedia devices come with various different ports, so that both of the audio/video sharing device and the multimedia device may have different corresponding ports, and each port has its own dedicated data transmission format incompatible with one another. For example, there are standard ports with HDMI specifications such as VIDEO, Y.Pb.Pr, VGA, and DVI.

Therefore, the methods for the multimedia device to share the audio/video signals with the public broadcasting equipment through the audio/video sharing device are mainly divided into two, respectively: a manual method and an automatic method.

In the manual method, the audio/video sharing device is connected to the public broadcasting equipment first. When a user wants to share the audio/video signal of the multimedia device with the public broadcasting equipment, the user retrieves the audio/video signal from a port of the multimedia device in advance, and then the audio/video signal is transmitted to the audio/video sharing device, and the user manually selects a signal switching key of the audio/video sharing device to transmit the audio/video signal to the public broadcasting equipment through the audio/video sharing device, and the manual control method is used to switch the public broadcasting device to a corresponding port capable of receiving the audio/video signal, so as to achieve the purpose of sharing the audio/video signals.

In the automatic method, the audio/video sharing device is connected to the public broadcasting equipment through a central controller (or engine room) indirectly. When the audio/video sharing device receives the audio/video signal, the central controller selects a correct port of the public broadcasting equipment according to the audio/video signal and the user's choice, so that the public broadcasting equipment can play the audio/video signal correctly.

Regardless of the manual method or the automatic method, after a conference or lecture ends, the user or maintenance personnel has to control the power of the playing device actively. In other words, the conventional methods not only consume more manpower resources, but also affect the service life of the playing device and waste energy, particularly when the user or maintenance personal forgets or neglects to turn off the playing device for a long time.

Therefore, the present invention provides a power-saving audio/video control device with the features of a plug and play function, automatic Power ON/OFF, power-saying, labor-saving, enhanced service life, automatic audio/video switch, and convenient operation to overcome the problems of the prior art.

### SUMMARY OF THE INVENTION

It is a primary objective of the present invention to provide a power-saving audio/video control device for determining whether a multimedia device generates an audio/video signal and deciding whether or not to display the audio/video signal at the public broadcasting system, so as to achieve the power-saving control of the public broadcasting system.

Another objective of the present invention is to provide the aforementioned power-saving audio/video control device with the features of a plug and play function, automatic Power ON/OFF, power saying, labor-saving, enhanced service life, automatic audio/video switch, and convenient operation.

Another objective of the present invention is to provide the aforementioned power-saving audio/video control device, wherein the multimedia device is plugged and installed to the input unit, and then a small signal retrieved from the audio/video signal is converted into a high potential signal or a low potential signal according to the audio/video signal generated by the multimedia device, and the processing unit is provided for determining whether to perform power management of the public broadcasting system.

Another objective of the present invention is to provide the aforementioned power-saving audio/video control device, wherein a plurality of audio/video signals generated by the multimedia device is selected, and one of the audio/video signals is selected to display at the public broadcasting system, so as to achieve the effect of sharing the audio/video signal of the multimedia device.

Another objective of the present invention is to provide the aforementioned power-saving audio/video control device, wherein the audio/video signals provided by the multimedia device are played at the public broadcasting system in a last-in-first-out (LIFO) order. As the last audio/video signal diminishes, the audio/video signal is switched back to the previous audio/video signal, and the public broadcasting system plays such previous audio/video signal until the multimedia device no longer provides any audio/video signal.

Another objective of the present invention is to provide the aforementioned power-saving audio/video control device, wherein the processing unit controls the public broadcasting system to be synchronously switched to a port which is the same type of port of the input unit according to the type of connectors (such as a VIDEO connector, a S-VIDEO connector, a YUV connector, a Y.Pb.Pr connector, a VGA connector, a DVI connector and a HDMI connector) connected to the media device, the input unit of the detection unit and the audio/video signal, so that the audio/video signal can be displayed at the public broadcasting system correctly.

To achieve the aforementioned and other objectives, the present invention provides a power-saving audio/video control device for determining whether to power on the public broadcasting system according to the status whether a multimedia device is connected and automatically selecting a source port, and the multimedia device is provided for playing audio/video signals at the public broadcasting system, and the power-saving audio/video control device comprises an input module, a detection unit and a control unit. Wherein, the input module is selectively coupled to the multimedia device, and the input module is coupled to the public broadcasting system and provided for receiving the audio/video signal; the detection unit is coupled to the input module and provided for detecting a connection status of the multimedia device with the input unit, and the multimedia device outputs the audio/video signal to generate a first control signal; and the control unit is installed between the input module and the detection unit and provided for receiving the first control signal to generate a corresponding second control signal, and the control unit controls the public broadcasting system according to the second control signal.

Compared with the prior art, the power-saving audio/video control device of the present invention determines whether to control the public broadcasting system after the multimedia device is plugged and connected to the input module directly, and detects by the detection unit whether the multimedia device is plugged to the input module and whether the multimedia device outputs an audio/video signal.

After the detection unit detects that the multimedia device has outputted the audio/video signal, a small signal is retrieved from the audio/video signal and converted into a high potential signal or a low potential signal, so that the control unit determines whether to control the power-on of the public broadcasting system and automatically select a signal source for the public broadcasting system according to the type of the source port, and the public broadcasting system plays the audio/video signal generated by the multimedia device correctly. On the other hand, if the audio/video signal diminishes and/or the multimedia device is turned off, then the power-saving audio/video control device of the invention will turn off the public broadcasting system automatically.

### BRIEF DESCRIPTION OF THE DRAWINGS

FIG. 1 is a schematic block diagram of a power-saving audio/video control device of the present invention; and

FIG. 2 is a schematic view of connecting a power-saving audio/video control device of the present invention.

### DESCRIPTION OF THE PREFERRED EMBODIMENTS

The objects, characteristics and effects of the present invention will become apparent with the detailed description of the preferred embodiments and the illustration of related drawings as follows.

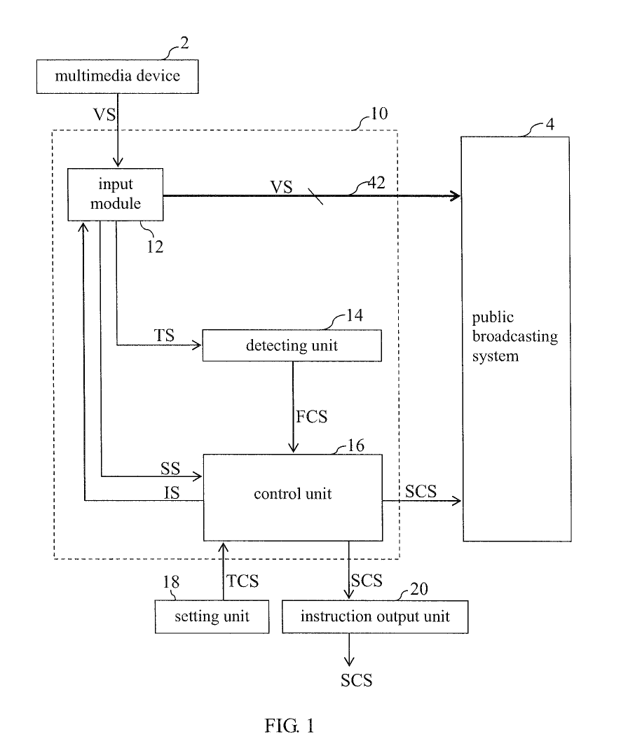

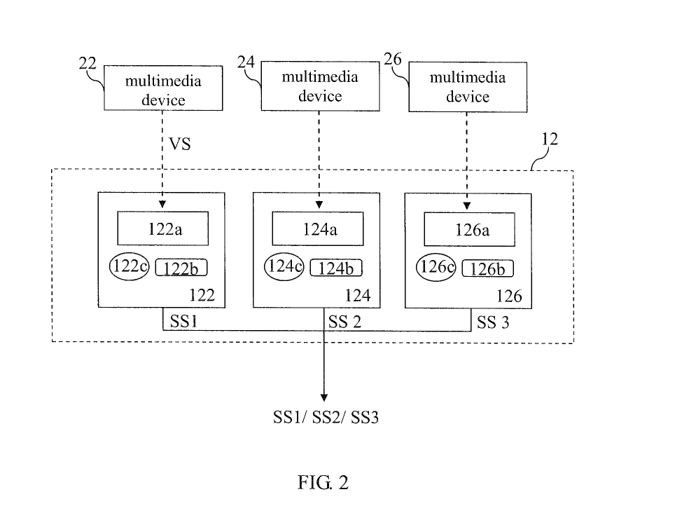

With reference to FIGS. 1 and 2 for a schematic block diagram of a power-saving audio/video control device and a schematic view of connecting the power-saving audio/video control device in accordance with the present invention respectively, the power-saving audio/video control device 10 determines the power-on of a public broadcasting system 4 according to a condition whether a multimedia device 2 is connected and automatically selects a source port, wherein the multimedia device 2 extendibly connects the audio/video signal VS to the public broadcasting system 4 through the power-saving audio/video control device 10. For example, the multimedia device 2 is a notebook computer, a desktop computer or a portable electronic device, and the public broadcasting system 4 is a projector or a display device.

Similarly, the public broadcasting system 4 has the same port of the multimedia device 2 such as a port for a VIDEO connector, a S-VIDEO connector, a YUV connector, a Y.Pb.Pr connector, a VGA connector, a DVI connector or a HDMI connector, and these connectors and these ports are connected with each other by a transmission line 42, so that the control of selecting the source port automatically can connect the connector of the multimedia device 2 to the port of the public broadcasting system 4 correctly to display the audio/video signal at the public broadcasting system 4 correctly.

Wherein, the power-saving audio/video control device 10 comprises an input module 12, a detection unit 14 and a control unit 16.

The input module 12 is selectively connected to the multimedia device 2, and the input module 12 is connected to the public broadcasting system 4. In FIG. 2, three input modules 12 (labeled as 122, 124 and 126 respectively) are used in this preferred embodiment for the purpose of illustrating the invention. In addition, each input module 122, 124, 126 comprises a connecting unit 122a, 124a, 126a, a switch unit 122b, 124b, 126b and an indicating unit 122c, 124c, 126c.

Wherein, the connecting units 122a, 124a, 126a are coupled to the multimedia device 22, 24, 26 separately. For example, the connecting unit 122a, 124a, 126a is a VIDEO connector, an S-VIDEO connector, a YUV connector, a Y.Pb.Pr connector, a VGA connector, a DVI connector or a HDMI connector.

The switch units 122b, 124b, 126b generate and transmit switch signals SS1, SS2, SS3 respectively (and all switch signals are labeled as SS in FIG. 1) to the control unit 16 to control the connecting units 122a, 124a, 126a to select one of the multimedia devices 22, 24, 26.

The indicating unit 122c, 124c, 126c is provided for indicating a connection status of the multimedia device 22, 24, 26. In other words, if one of the multimedia devices 22, 24, 26 is selected by the control unit 16 or specified by users, then the corresponding indicating unit 122c, 124c, 126c will display a corresponding indication to let the user know about the current selected status of the multimedia device 22, 24, 26.

In FIG. 1, the detection unit 14 is coupled to the input module 12 and provided for detecting the connecting status of the multimedia device 2 with the input unit 12 and the signal status of the audio/video signal VS after the multimedia device 2 is coupled to the input unit 12. Wherein, the connecting status is defined as the status whether or not the multimedia device 2 is plugged and installed, and whether or not the multimedia device 2 has generated an audio/video signal VS, and the detection unit 14 retrieves and converts a small signal of the audio/video signal VS into a high-voltage or low-voltage trigger signal TS. The detection unit 14 outputs a first control signal FCS to the control unit 16 according to the trigger signal.

The control unit 16 is installed between the input module 12 and the detection unit 14 and provided for generating a corresponding second control signal SCS according to the first control signal FCS to drive the control unit 16 to control the Power ON/OFF of the public broadcasting system 4 based on the second control signal SCS, and automatically switch to a source port of the public broadcasting system 4, so that the public broadcasting system 4 can play the audio/video signal VS correctly.

Therefore, the control unit 16 transmits the second control signal SCS to the public broadcasting system 4 through a RS232 interface or a RS485 interface. In another preferred embodiment, the control unit 16 can be a wireless transmission module (not shown in the figure) provided for transmitting the second control signal SCS to the public broadcasting system 4 via a wireless transmission such as infrared, Bluetooth or wireless fidelity (Wi-Fi) to control Power ON/OFF of the public broadcasting system 4. It is noteworthy that the public broadcasting system 4 may also have another wireless transmission module identical to the wireless transmission module in the wireless transmission mode.

In another preferred embodiment, the power-saving audio/video control device 10 further comprises a setting unit 18 and an instruction output unit 20. Wherein, the setting unit 18 and the instruction input unit 20 are coupled to the control unit 16. The setting unit 18 generates a third control signal TCS to control the control unit 16. For example, the third control signal TCS is provided for setting a Power ON/OFF time and a Power OFF sequence; and, the instruction output unit 20 is provided for outputting the second control signal SCS for the application of a peripheral device. For example, the instruction output unit 20 controls the brightness of a lamp, or the ascending and descending of a curtain according to the second control signal SCS.

Further, the control unit 16 further generates an indicating signal IS according to the first control signal FCS, in addition to the corresponding second control signal SCS. In FIG. 2, the indicating signal IS is provided for the indicating unit 122c, 124c, 126c to indicate the connecting status of the multimedia device 22, 24, 26. For example, the indicating unit 122c, 124c, 126c is a light emitting diode used to indicate the current input status of the multimedia device 22, 24, 26 by a blinking state, a constantly ON state, or a constantly OFF state of the light emitting diode.

In FIGS. 1 and 2, several multimedia devices 22, 24, 26 are used for the purpose of illustrating the invention.

If a user plugs or installs the multimedia device 22, 24, 26 with the connecting units 122a, 124a, 126a, and only the multimedia device 22 has an audio/video signal VS, then the detection unit 14 will detect and determine that the connecting units 122a has an input of the audio/video signal VS, and the detection unit 14 retrieves a voltage signal (such as a high potential) from the audio/video signal VS to generate and transmit the first control signal FCS to the control unit 16. Wherein, the connecting unit 122a, 124a, 126a is coupled to the public broadcasting system 4 in advance.

Now, the control unit 16 drives the indicating unit 122c of the connecting units 122a to be lit, and the control unit 16 generates and transmits the second control signal SCS to the public broadcasting system 4 and turns on the public broadcasting system 4, so that the public broadcasting system 4 can play the audio/video signal VS. If the user turns off the multimedia device 2 or does not input any audio/video signal VS for a long time, then the voltage signal will drop from a high potential to a low potential or even to no potential, so that the control unit 16 will output the second control signal SCS to turn off the public broadcasting system 4 in order to achieve the effects of reducing the waste of energy, saving labor costs for maintenance and operation, and preventing negligence of the personnel.

If the multimedia device 22, 24, 26 is plugged, and the audio/video signal VS, VS1, VS2 is generated, the switch unit 122b, 124b, 126b will base on the sequence of connecting the multimedia device 2 and the connecting unit 4 (such as connecting the audio/video signal VS2 after connecting the audio/video signal VS1, or connecting the audio/video signal VS1 after connecting the audio/video signal VS) to transmit the audio/video signal VS2 generated by the multimedia device 26 lastly coupled to the connecting unit 12 to the public broadcasting system 4.

After the audio/video signal VS2 is withdrawn, an ON state of the audio/video signal VS1 is switched, and so forth, until no audio/video signal is generated, and the control unit 16 turns off the public broadcasting system 4 to achieve the following effects:

(1) The present invention provides a plug and play function and saves energy effectively. If a user no longer uses the device, the system will be turned off automatically.

(2) The present invention allows the public broadcasting system 4 to save power automatically without requiring additional maintenance personnel to save labor cost.

(3) The present invention detects whether or not the audio/video signal VS exists in order to warm up the public broadcasting system in advance and enhance the service life of the public broadcasting system.

(4) The present invention automatically switches through the audio/video signal VS and provides a convenient operation.

(5) The control signal generated by an input module is provided for controlling the public broadcasting unit to be switched to a correct source port according to the type of the connecting unit.

In the power-saving audio/video control device of the present invention, the multimedia device is plugged and installed to the input module directly, and the detection unit is used to detect a connecting status, or whether or not the input unit is plugged and installed with the multimedia device, and the detected result is provided for the control unit to determine the Power ON/OFF of the pubic broadcasting system and play the audio/video signal generated by the multimedia device at the public broadcasting system.

While the invention has been described by means of specific embodiments, numerous modifications and variations could be made thereto by those skilled in the art without departing from the scope and spirit of the invention set forth in the claims.

What is claimed is:

1. A power-saving audio/video control device, determining whether to control a power supply of a public broadcasting system and automatically selecting a source port based on whether the power-saving audio/video control device is coupled to a multimedia device, and the multimedia device being used in the public broadcasting system to play an audio/video signal, comprising:
an input module, selectively coupled to the multimedia device, and the input module being coupled to the public broadcasting system, for receiving the audio/video signal;
a detection unit, coupled to the input module, for generating a first control signal according to a connecting status of the multimedia device with the input unit, and the multimedia device outputting the audio/video signal; and
a control unit, installed between the input module and the detection unit, for receiving the first control signal to generate a corresponding second control signal, and the control unit controlling the public broadcasting system according to the second control signal.

2. The power-saving audio/video control device of claim 1, wherein the control unit further comprises a wireless transmission module, and the wireless transmission module transmits the second control signal to the public broadcasting system via a wireless transmission.

3. The power-saving audio/video control device of claim 2, wherein the wireless transmission module is one selected from the collection of an infrared (IR) module, a Bluetooth module and a wireless fidelity (Wi-Fi) module.

4. The power-saving audio/video control device of claim 1, wherein the control unit further comprises a cable transmission module, and the wireless transmission module transmits the second control signal to the public broadcasting system through a RS232 interface or a RS485 interface.

5. The power-saving audio/video control device of claim 1, further comprising a setting unit and an instruction output unit, and the setting unit and the instruction output unit are coupled to the control unit separately, and the setting unit generates a third control signal for controlling the control unit, and the instruction output unit is provided for the control unit to output the second control signal.

6. The power-saving audio/video control device of claim 1, wherein the control unit generates an indicating signal according to the corresponding first control signal.

7. The power-saving audio/video control device of claim 6, wherein the input module further comprises a connecting unit, a switch unit and an indicating unit, and the connecting unit is coupled to the switch unit, and the connecting unit is provided for coupling the multimedia device, and the switch unit switches the connecting unit to receive the audio/video signal, and the switch unit generates a switch signal to the control unit for the control unit to control the public broadcasting system to receive the audio/video signal, and the indicating unit is provided for displaying the indicating signal.

8. The power-saving audio/video control device of claim 7, wherein the switch unit performs a switch between the connecting units, if a plurality of connecting units is installed.

9. The power-saving audio/video control device of claim 8, wherein the switch unit according to the order of connecting the multimedia device and the connecting unit and a last-in-first-out (LIFO) method is used to transmit the audio/video signal generated by the multimedia device which is lastly connected to the connecting unit to the public broadcasting system according to the audio/video signal of the connecting unit.

10. The power-saving audio/video control device of claim 7, wherein the connecting unit is one selected from the collection of a VIDEO connector, a S-VIDEO connector, a YUV connector, a Y.Pb.Pr connector, a VGA connector, a DVI connector and a HDMI connector.

11. The power-saving audio/video control device of claim 7, wherein the indicating unit is a light emitting diode.
